(19) United States
(12) Patent Application Publication
(10) Pub. No.: US 2009/0139982 A1
(43) Pub. Date: Jun. 4, 2009

(54) Power Delivery To Heater Elements

(76) Inventors: Jichang Cao, Lexington, KY (US); James Douglas Gilmore, Lexington, KY (US); Calvin Dale Murphy, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/946,948

(22) Filed: Nov. 29, 2007

(51) Int. Cl. H05B 1/02

(52) U.S. Cl. 219/492; 219/494

(57) ABSTRACT

Fuser heater element damage due to excessive heating power is prevented by estimating available power supply heating power for proper power control. The estimate is performed by applying a predefined portion of the heating power available from the power supply to the heater element. The predefined portion is determined so that the heater element will not be damaged even if the power supply is at the maximum voltage level of any power supply that may be encountered. The temperature of the heater element is measured, and, if below a predefined temperature, a heating power estimate is made. If not, the heater element is heated by applying power in accordance with a stored heating power estimate from the last heating power estimate. A heating power estimate is made each time the heating element is heated from a temperature below the predefined temperature.

### FIELD OF THE INVENTION

The present invention relates generally to the delivery of power to an electrical load. More particularly, the present invention relates to a method and apparatus for delivering power to a heater element in a fuser of an imaging device to ensure that appropriate levels of power are delivered to the element over a range of supply voltages which vary widely depending where in the world power is accessed and the operating conditions of a power system being accessed.

### BACKGROUND OF THE INVENTION

It is desirable for imaging devices to be able to operate from any available power supply regardless of the voltage level provided by the supply. Wide variations in AC line voltages are encountered around the world varying from a low of about 90 volts to a high of about 254 volts depending on where one is using the commercially available power. When power is provided to an imaging device that uses a fuser, such as a laser printer, it is important to provide adequate power to quickly increase the temperature of a heating element or elements within the device so that images or prints can be made as soon as possible after powering up the device. Rapid heating must be balanced with the need to control the power supplied to the device so that the heating element(s) are not damaged, particularly during initialization of the printing device when the heating element(s) are cold.

If excessive power is applied to a heating element, its usable life can be shortened or the heating element can be damaged or destroyed. For example, ceramic heater elements employed in some printers will crack when excessive AC line voltages are encountered and proper power control is not implemented. Additionally, the risk of heater cracking is heightened when excessive power is applied for multiple sheet feed during print (i.e. the paper pick picks several sheets for print rather than a single sheet).

### SUMMARY OF THE INVENTION

In accordance with the invention of the present application, heater element damage, such as cracking, due to excessive heating power is prevented. The heating power available from a power supply is estimated so that the application of power to the heating element can be properly controlled so that a desired heating power level can be applied to the heater element. The estimate is performed by applying a predefined portion of the heating power available from the power supply to the heater element. The predefined portion is determined so that the heater element will not be damaged even if the power supply provides power at the maximum voltage level of any source of power that the fusing assembly may encounter. The temperature of the heater element is measured, and, if the heater element temperature is below a predefined temperature, a heating power estimate is made. If not, the heater element is heated by applying power in accordance with a previously stored heating power estimate which resulted from the last heating power estimation. A heating power estimate is made each time the heating element is heated from a temperature below the predefined temperature.

In accordance with one aspect of the invention, a method for controlling power delivered to a heater element in a fusing assembly from a source of power comprises measuring a heater element temperature and applying power to the heater element as a predefined portion of the heating power available from the source of power if the temperature of the heater element is below a predefined temperature. The rate of temperature increase of the heater element is determined when being heated with the predefined portion of the heating power available from the source of power. Heating power delivered to the heater element is calculated from the rate of temperature increase of the heater element and saved. Power is then applied to the heater element as a portion of the heating power available from the source of power based on the calculated heating power.

In accordance with another aspect of the invention, a method for controlling power delivered to a heater element in a fusing assembly from a source of power comprises measuring a heater element temperature and applying power to the heater element as a predefined portion of the heating power available from the source of power if the temperature of the heater element is below a predefined temperature. The rate of temperature increase of the heater element when being heated with said predefined portion of the heating power available from the source of power is then determined. The rate of temperature increase of the heater element is used to determine the heating power delivered to the heater element and saved. A desired portion of the heating power available from the source of power is then determined from the saved heating power for application to the heater element and power is applied to the heater element as the desired portion of the determined heating power.

In accordance with an additional aspect of the invention, a fusing assembly comprises a heater element and means for measuring a temperature of the heater element. A controller is programmed to apply power from a power source to the heater element as a predefined portion of the heating power available from the source of power if the temperature of the heater element is below a predefined temperature. The controller then determines the rate of temperature increase of the heater element when being heated with the predefined portion of the power available from the source of power and calculates heating power delivered to the heater element from the rate of temperature increase of the heater element. The calculated heating power is saved and power is applied from the power source to the heater element as a portion of the calculated heating power.

### BRIEF DESCRIPTION OF THE DRAWINGS

The following detailed description of the preferred embodiments of the present invention can best be understood when read in conjunction with the following drawings, where like structure is indicated with like reference numerals, and in which:

FIG. 1 is a schematic illustration of an electrophotographic printer including a fuser assembly operable in accordance with the invention; and

FIG. 2 is a side view, partially in cross section, of the fuser assembly illustrated in FIG. 1.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

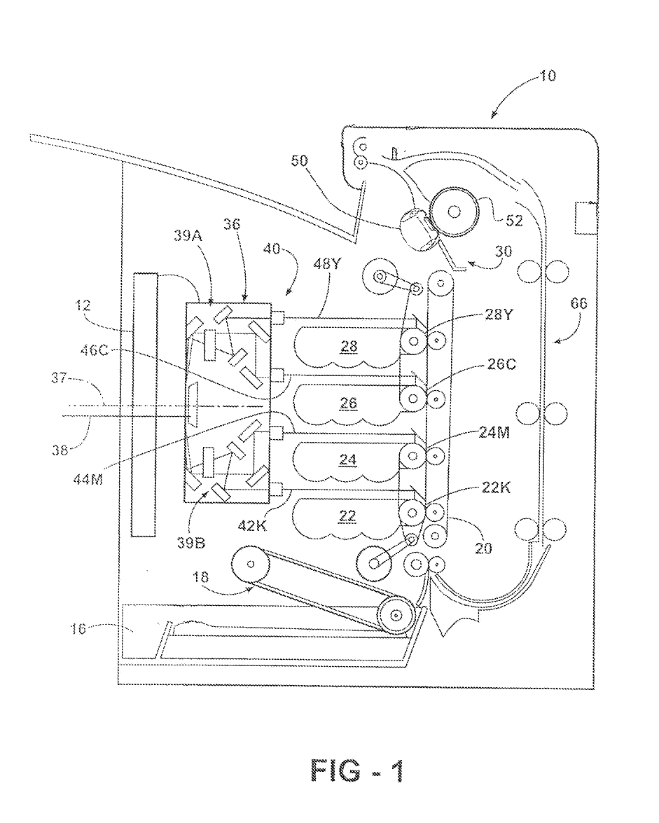

FIG. 1 depicts an electrophotographic image forming apparatus comprising a color laser printer, which is indicated generally by the numeral 10. An image to be printed is electronically transmitted to a print engine processor or controller 12 by an external device (not shown) or may comprise an image stored in a memory of the controller 12. The controller 12 includes system memory, one or more processors, and other logic necessary to control the functions of electrophotographic imaging, substrate transport and fusing.

In performing a print operation, the controller 12 initiates an imaging operation where a top substrate of a stack of media is picked up from a media tray 16 by a pick mechanism 18 and is delivered to a media transport belt 20. The media transport belt 20 carries the substrate passed each of four image forming stations 22, 24, 26, 28, which apply toner to the substrate. The image forming station 22 includes a photoconductive drum 22K that delivers black toner to the substrate in a pattern corresponding to a black (K) image plane of the image being printed. The image forming station 24 includes a photoconductive drum 24M that delivers magenta toner to the substrate in a pattern corresponding to the magenta (M) image plane of the image being printed. The image forming station 26 includes a photoconductive drum 26C that delivers cyan toner to the substrate in a pattern corresponding to the cyan (C) image plane of the image being printed. The image forming station 28 includes a photoconductive drum 28Y that delivers yellow toner to the substrate in a pattern corresponding to the yellow (Y) image plane of the image being printed. The controller 12 regulates the speed of the media transport belt 20, media pick timing, and the timing of the image forming stations 22, 24, 26, 28 to effect proper registration and alignment of the different image planes to the substrate.

To effect the imaging operation, the controller 12 manipulates and converts data defining each of the KMCY image planes into separate corresponding laser pulse video signals, and the video signals are then communicated to a printhead 36. The printhead 36 may include four laser light sources (not shown) and a single polygonal mirror 38 supported for rotation about a rotational axis 37, and post-scan optical systems 39A, 39B receiving the light beams emitted from the laser light sources. Each laser of the laser light sources emits a respective laser beam 42K, 44M, 46C, 48Y, each of which is reflected off the rotating polygonal mirror 38 and is directed towards a corresponding one of the photoconductive drums 22K, 24M, 26C, 28Y by select lenses and mirrors in the post-scan optical systems 39A, 39B.

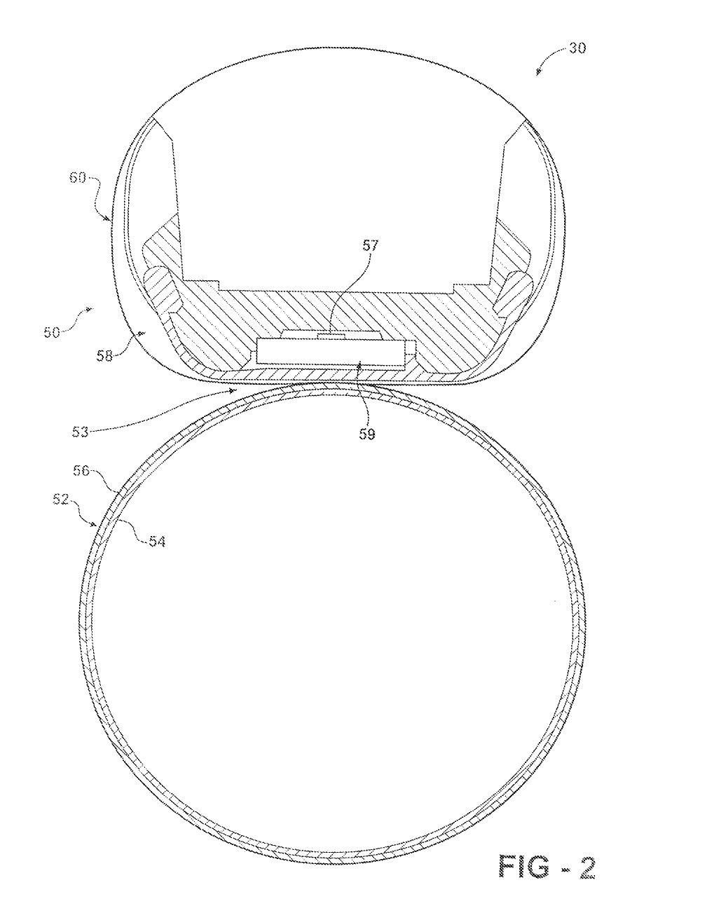

The media transport belt 20 then carries the substrate with the unfused toner image planes superposed thereon to a fuser assembly 30. The fuser assembly 30 may comprise a heater assembly 50 defining a heat transfer member and a backup roller 52 defining a pressure member cooperating with the heater assembly 50 to define a fusing nip 53 through which substrates are conveyed. As shown in FIG. 2, the heater assembly 50 may comprise a housing structure 58 defining a support member, a heater element 59 supported on the housing structure 58, and an endless fuser belt 60 positioned about the housing structure 58. A temperature sensor 57, such as a thermistor, is coupled to a surface of the heater element 59 opposite a heater surface in contact with the belt 60. For additional details regarding the fuser assembly 30, reference can be made to U.S. Pat. No. 7,235,761, which is assigned to the assignee of the present application and is incorporated herein by reference.

AC line voltage can vary from around 90 volts to around 254 volts depending on where in the world one is using the commercially available AC power. Such a large line voltage range can result in large differences in heating power applied to a fuser of an imaging device unless proper power control is provided. For example, the heating power applied to a fuser heater element rated at 1200 watts at 120 volts varies from about 730 watts at 90 volts to about 5610 watts at 254 volts. The noted fuser heater element is a ceramic heater intended for use at a nominal supply voltage of 115 volts AC and will crack when a printer including the fuser is plugged into an AC outlet with line voltage above 130 volts if the power is not controlled properly to protect the heater element. The risk of cracking heater elements with excessive power at high line voltage is increased for double or triple sheet feeds during printing. In addition, excessive power at high line voltage during printing can cause severe light flicker. It is also very difficult to achieve tight fusing belt temperature control for all AC line conditions due to such large heating power variations.

Accordingly, the heating power must be tightly controlled at required power levels to prevent heater element cracking and to meet temperature control requirements no matter what AC line conditions are encountered. In order to achieve tight heating power control for all AC line conditions, it is necessary to detect AC line conditions. Once the AC line conditions are known, a power control technique can be used, for example, PWM can be used to control heating power at certain levels by changing duty cycles of the applied power. Power levels are determined to meet different power requirements for different fusing conditions, such as during preheat to warm grease for friction reduction, for fast warm-up to reduce first copy time, and application of different power levels required for tight temperature control for different types of media being printed.

AC line voltage detection is also necessary for proper control of fusing belt temperatures when a thermistor is not used to measure fusing belt temperature directly. For printers using such fusers, the fuser temperature control has to predict or estimate belt temperature based on heater temperature and other operating conditions, such as printing speed, inter-page gap, fan speed and the like. The fuser operating temperature window for such printers can be small, less than 20° C. (68° F.) for currently used toners. Large heating power variations due to large AC line voltage variations can have significant effects on heater temperature response, and heater temperature response will affect fusing belt temperature response. Therefore, it can be impossible to accurately predict belt temperature response for all those heating power conditions. In order to maintain fusing belt temperature within the operating temperature window, heating power variation due to AC line voltage conditions must be tightly controlled to certain levels. In other words, heating power must be tightly controlled so that a heater is able to deliver constant power levels for fuser warm-up and print regardless of the AC line conditions. Otherwise, large heating power variations can cause big belt temperature variations, overshoot at high line voltage and undershoot at low line voltage. The large belt temperature variations could exceed the fusing temperature window and cause hot offset or poor fuse grade.

One way to detect AC line voltage is to add a current sensor to a power supply so that a current feedback loop can be provided for the supply. Based on the feedback current level, AC line voltage can be determined. Since a current feedback loop has to be implemented into the power supply, it would increase the cost of the power supply. In accordance with the teachings of the present application, the relation of heater temperature response and heating power are used to estimate AC line voltage and/or heating power. Contrasted to the current feedback solution, it adds no cost to a printer.

Heater temperature response is a function of heating power. It increases or decreases as heating power increases or decreases. However, heater temperature response can also be affected by heat conduction and convection variations due to fuser rotation speed, cooling fan speed, ambient conditions and the like. Therefore, the conditions for making a heating power estimate are very important and have significant effects on the accuracy of the estimate.

To reduce the effect of factors other than heating power that can affect heater temperature response, the heating power estimation of the present application is performed only when a fuser is cold and the fuser is stationary. When a fuser is cold and stationary, the effects of other factors, such as those noted above, on heater temperature response are small and can be ignored. Heating power is the one dominant variable of heater temperature response so that under the above estimation conditions, the relation of heating power and heater warm-up time from a first temperature, such as about 60° C. (140° F.) to a second temperature, such as about 90° C. (194° F.), can be used to estimate heating power. It is contemplated that other temperatures and other temperature ranges can be used in accordance with the invention of the present application. In addition, heater temperature increase for a given period of power application can also be used to determine the rate of temperature increase of a heater element.

In accordance with the teachings of the present application, the prevention of heater element cracking due to excessive heating power during heating power estimation is performed by applying power to the heater element as a predefined portion of the heating power available from the source of power. That is, a portion of the total heating power that the source of power would provide if it was applied without any power control. Power control to reduce the total available power to a predefined portion of the total power can be performed in a number of ways that will be well known to those skilled in the art. For example, PWM power control may be used as disclosed in U.S. Pat. No. 6,927,368, which is assigned to the assignee of the present application and is incorporated herein by reference. More particularly, while making a heating power estimate, the duty cycle is controlled so that the predefined portion of the total heating power is applied to the heater element.

The predefined or default portion of the total power is determined so that the heater element will not be damaged even if the voltage level of the power source is at the maximum voltage level of any source of power that the fusing assembly may encounter. To improve the efficient operation of a printer, it may be desirable to set the maximum voltage level to correspond to the maximum expected voltage level that can be expected for a region within which the printer is designed to operate, i.e., the U.S. (nominal 115 volts AC), Europe (nominal 230 volts AC), etc.

The temperature of the heater element is measured and monitored, and, if the heater element temperature is below a threshold temperature, estimation of the heating power is performed and the resulting heating power estimate is stored for later use. If not, the heater element of the fuser assembly is heated by applying power in accordance with a previously stored heating power estimate which resulted from the last heating power estimation. During a working operating period of a printer, such as the work day in a business setting, the printer will normally have periods when it is not operating. During such times, the printer may be placed into an idle mode wherein the fuser may be maintained within a defined temperature range, such as from 100° C. (212° F.) to 120° C. (248° F.), for a period of time, such as 30 minutes. The idle printer mode anticipates that a printing job will be received within the idle time period and, for such jobs, the printer can rapidly provide a first print. When the idle time period expires, the printer may be placed in the power saver mode and power turned off to the fuser. When activated from the power saver mode, a heating power estimate will be made if the fuser temperature has fallen below the threshold temperature, for example 50° C. (122° F.).

An illustrative power up procedure in accordance with the disclosure of the present application will now be described. After a printer is turned on and initialization is finished, a fuser controller, such as the controller 12, reads the temperature of the heater element of the fuser. While the structure of the fuser is not important to the invention of the present application and forms no part of the present invention, as previously noted, reference can be made to U.S. Pat. No. 7,235,761, which discloses an exemplary belt fuser structure.

If the heater element temperature is below a threshold temperature, 50° C. (122° F.) in a working embodiment, the controller 12 checks or estimates the AC line voltage by making a heating power estimate. If a motor (not shown) of the fuser assembly 30 is operating, the motor is stopped prior to making the estimate. When PWM power control is used, the PWM duty cycle is set so that the default portion of the total power is applied to the heater element. This PWM duty cycle prevents possible heater damage, for example cracking of a ceramic heater, from excessive heating power due to potentially high line voltage. The default duty cycle of the PWM power control corresponding to the default portion of the total power should be selected based on the thermal shock resistance property of the heater element and the fuser warm-up time requirement. If the duty cycle is set too low, the heating power will be inadequate and it will increase the fuser warm-up time. If the duty cycle is set too high, excessive heating power due to high line voltage could damage the heater element.

In a working embodiment, a 29% default duty cycle was selected for a printer having a fuser heater element intended for operation from a nominal 115 volt AC power supply. Of course, the actual default duty cycle will depend on the range of possible line voltages that may be encountered, the particular heater element(s) used in the fuser assembly and the like, as will be apparent to those skilled in the art.

Power is then applied at the default duty cycle to the heater element to provide the default portion of the total power and the temperature of the heater element is measured and monitored. When the temperature of the heater element reaches 60° C. (140° F.), a fuser timer is reset to zero and started to time. When the heater element temperature reaches 90° C. (194° F.), the fuser timer is stopped and read to determine the warm-up time from 60° C. (140° F.) to 90° C. (194° F.) which is saved and used to calculate the heating power and to estimate the AC line voltage. Other temperatures and temperature ranges may be used in accordance with the teachings of the present application and the necessary data can also be obtained by starting the fuser timer, measuring and recording the heater element temperature, stopping the timer after a predefined time period and again measuring and recording the heater element temperature. In a working embodiment, temperature measurement and the start of the timer are performed at substantially the same time. Of course it will be understood that simultaneous temperature measurement and timer start/stop are not necessary since the timer can be started/stopped just before or just after the temperature is measured. Other techniques for controlling the power and for determining the rate of temperature increase of the heater element will also be apparent to those skilled in the art in view of the disclosure of the present application.

In a working embodiment, the calculation is performed using linear interpolation based on the 60° C./90° C. warm-up time and a table that relates AC voltage level to heating power and heater element warm-up time, see exemplary table 1 below.

TABLE 1
Voltage, 29% Full Power, Heater Warm-up Time and Heating Rate

| | | Warm-Up | |
|---|---|---|---|
| | Heating Power (W) | Time from 60° C. | |
| Volts | (at 29% Duty Cycle) | to 90° C. (ms) | Heating Rate (° C./sec) |
| 85 | 176 | 2070 | 14.492 |
| 90 | 205 | 1795 | 16.713 |
| 95 | 225 | 1605 | 18.692 |
| 100 | 249 | 1445 | 20.761 |
| 105 | 274 | 1284 | 23.364 |
| 110 | 303 | 1153 | 26.019 |
| 115 | 327 | 1043 | 28.763 |
| 120 | 353 | 953 | 31.480 |
| 125 | 387 | 841 | 35.672 |
| 130 | 420 | 781 | 38.412 |
| 135 | 447 | 701 | 42.796 |
| 140 | 485 | 651 | 46.083 |
| 145 | 515 | 607 | 49.423 |

The heating power estimate and/or AC line voltage is saved, for example to EEPROM or flash memory in the controller 12. When the printer is turned on and the heater element temperature is greater than or equal to 50° C. (122° F.), a heating power estimate is not made but rather fuser power control uses a previously saved heating power estimate.

To accurately predict fuser temperature, fuser belt temperature in the case of the fuser of the referenced '761 patent, the heating power must be tightly controlled for all possible AC line voltages. If the heating power is too high, it could cause excessive light flicker and temperature overshoot. If the heating power is too low, it could cause temperature droop for the first several sheets printed. In accordance with the disclosure of the present application, the required heating power is met for all AC line voltage conditions by calculating a PWM duty cycle, phase angle or other appropriate power control parameter that provides a desired heating power. An example of the heating power estimate calculation will now be provided.

When the printer is turned on and the heater element temperature is less than 50° C. (122° F.), a heating power estimate is made by measuring the heater element warm-up time from 60° C. (140° F.) to 90° C. (194° F.). If the 60° C./90° C. warm-up time is 900 milliseconds (ms), from Table 1, the line voltage is higher than 120 volts and lower than 125 volts. The heating power can be calculated using linear interpolation using the general equation:

y=y₀+(x−x₀)*((y₁−y₀)/(x₁−x₀))

Where y=power and x=warm-up time (y₀=lower power level from table 1; y₁=higher power from table 1; x=measured warm-up time; x₀=warm-up time for lower power level from table 1; and x₁=warm-up time for higher power level from table 1). Thus, heating power at 29% duty cycle (HP₂₉) is determined from the equation:

HP₂₉=353+(900−953)*((387−353)/(841−953))=369 watts;

the AC line voltage is determined from the comparable linear interpolation equation:

V_{AC}=120+(900−953)*((125−120)/(841−953))=122.598 volts; and

the heating power at the AC line voltage is determined by the equation:

Heating power=369 W*(100/29)=1272.7 watts

For delivery of a desired heating power to the heating element of the fuser assembly, for example 800 watts of power, the duty cycle for the PWM power control is determined from the equation:

PWM Duty Cycle for Print=(800/1272.7)*100%=62.8%

Accordingly, for the above AC line condition, PWM power control can deliver 800 W heating power for print by setting the PWM duty cycle at 62.8%. For all possible AC line voltages, the PWM duty cycle can be calculated in the same way. By resetting the PWM duty cycle, the heater element can deliver substantially constant heating power during print regardless of the AC line voltage conditions.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for controlling power delivered to a heater element in a fusing assembly from a source of power, said method comprising:
measuring a heater element temperature;
applying power to the heater element as a predefined portion of the heating power available from the source of power if the temperature of the heater element is below a predefined temperature;
determining the rate of temperature increase of the heater element when being heated with said predefined portion of the heating power available from the source of power;
calculating heating power delivered to the heater element from said rate of temperature increase of said heater element;
saving the calculated heating power; and
applying power to the heater element as a portion of the heating power available from the source of power based on the calculated heating power.

2. The method of claim 1 further comprising applying power to the heater element as a portion of the heating power available from the source of power based on said saved calculated heating power if the heater element temperature is at or above said predefined temperature.

3. The method of claim 1 wherein determining the rate of temperature increase of the heater element comprises:
heating said heater element to a first temperature;
heating said heater element from said first temperature to a second temperature higher than said first temperature;
measuring the elapsed time for the temperature of the heater element to increase from said first temperature to said second temperature; and
calculating the rate of temperature increase of the heater element based on said elapsed time.

4. The method of claim 3 wherein said first temperature is about 60° C. (140° F.).

5. The method of claim 4 wherein said second temperature is about 90° C. (194° F.).

6. The method of claim 1 wherein determining the rate of temperature increase of the heater element comprises:
starting a timer;
measuring a first temperature of the heater element;
stopping said timer after a predefined time period;
measuring a second temperature of the heater element; and
calculating the rate of temperature increase of the heater element based on said predefined time period and said first and second temperatures.

7. The method of claim 1 further comprising estimating the voltage of the source of power.

8. The method of claim 1 further comprising:
determining whether a motor of the fuser assembly is operating; and
stopping said motor if operating before applying power to the heater element as said predefined portion of the heating power available from the source of power.

9. The method of claim 1 wherein said predefined portion of the heating power available from the source of power is selected to prevent damage to the heater element regardless of the voltage level of the source of power.

10. The method of claim 1 wherein said predefined portion of the heating power available from the source of power is used for default power application.

11. The method of claim 10 wherein said default power application is set at approximately 29% of the heating power available from the source of power.

12. The method of claim 11 wherein said default power application is set in accordance with the maximum voltage level of any source of power with which the fusing assembly is designed to operate.

13. The method of claim 11 wherein said default power application is set based on a region of the world for which the fusing assembly is intended to be used.

14. The method of claim 1 wherein said predefined portion of the heating power available from the source of power is set so that the power applied to the heater element is substantially the same regardless of the voltage level of the source of power.

15. A method for controlling power delivered to a heater element in a fusing assembly from a source of power, said method comprising:
measuring a heater element temperature;
applying power to the heater element as a predefined portion of the heating power available from the source of power if the temperature of the heater element is below a predefined temperature;
determining the rate of temperature increase of the heater element when being heated with said predefined portion of the heating power available from the source of power;
determining heating power delivered to the heater element from said rate of temperature increase of said heater element;
saving the determined heating power;
determining a desired portion of the heating power available from the source of power for application to the heater element based on the saved heating power; and
applying power to the heater element as the desired portion of the saved heating power.

16. A fusing assembly comprising:
a heater element;
means for measuring a temperature of said heater element;
a controller programmed to:
apply power from a power source to the heater element as a predefined portion of the heating power available from the source of power if the temperature of the heater element is below a predefined temperature;
determine the rate of temperature increase of the heater element when being heated with said predefined portion of the power available from the source of power;
calculate heating power delivered to the heater element from said rate of temperature increase of said heater element;
save the calculated heating power; and
apply power from said power source to the heater element as a portion of the calculated heating power.

17. The fusing assembly of claim 16 wherein said controller is further programmed to apply power to the heater element as the portion of the saved calculated heating power if the heater element temperature is at or above said predefined temperature.

18. The fusing assembly of claim 17 wherein said controller is further programmed to:
determine whether a motor of the fuser assembly is operating; and,
stop said motor if operating before applying power to the heater element at said predefined portion of the heating power available from the source of power.

19. The fusing assembly of claim 18 wherein said predefined portion of the heating power available from the source of power is set in accordance with the maximum voltage level of any source of power with which said fusing assembly is designed to operate.

20. The fusing assembly of claim 16 wherein the power applied to the heater element at said portion of the calculated heating power is substantially the same regardless of the voltage level of said power source.
